(19) United States
(12) Patent Application Publication
(10) Pub. No.: US 2021/0162955 A1
(43) Pub. Date: Jun. 3, 2021

(54) ADAPTER AND WIPER DEVICE HAVING THE SAME

(71) Applicant: CAP Corporation, Gyeongsangbuk-do (KR)

(72) Inventor: Yun Soo KIM, Gyeongsangbuk-do (KR)

(21) Appl. No.: 17/034,620

(22) Filed: Sep. 28, 2020

(30) Foreign Application Priority Data
Nov. 29, 2019 (KR) 10-2019-0157444

(51) Int. Cl. B60S 1/40

(52) U.S. Cl. CPC B60S 1/40

(57) ABSTRACT

A wiper device is disclosed. A wiper device coupled to a wiper arm to remove a foreign substance, may include: a contact member configured to wipe off the foreign substance; a support member configured to elastically support the contact member to be in close contact with a windshield; an adapter coupled to the wiper arm; and an adapter coupling member comprising a first coupling member coupled to the support member and a second coupling member coupled to the adapter and rotated to be fastened and released after being fitted into the first coupling member.

### CROSS REFERENCE TO RELATED APPLICATION(S)

This application claims the benefit under 35 USC § 119(a) of Korean Patent Application No. 10-2019-0157444 filed on Nov. 29, 2019 in the Korean Intellectual Property Office, the entire disclosure of which is incorporated herein by reference for all purposes.

### BACKGROUND

### 1. Field

The present invention relates to a wiper device.

### 2. Description of Related Art

When a windshield of a vehicle in driving is contaminated by various substances, including debris in the atmosphere or rain or snow, it becomes difficult to secure a clear view and can affect the safety of driving. Thus, a wiper for clearing snow, rain, or debris is equipped on the windshield in order to secure the clear view for the safety of a driver. The wiper device is connected to a wiper arm installed in the vehicle and is operated by the wiper arm.

The wiper device is connected to a wiper arm installed in the vehicle by an adapter and is operated by the wiper arm.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present invention provides a wiper device that can be firmly coupled to a wiper arm and be attached to and detached from the wiper arm.

According to an aspect of the present invention, there is provided a wiper device that removes a foreign substance attached to a windshield and is connected to a wiper arm, including: a contact member configured to wipe off the foreign substance; a support member configured to elastically support the contact member to be in close contact with the windshield; an adapter coupled to the wiper arm; and an adapter coupling member including a first coupling member coupled to the support member and a second coupling member coupled to the adapter and rotated to be fastened or released after being fitted into the first coupling member.

With the wiper device according to the present invention, the adapter can be easily mounted since the adapter coupling member includes two members which are fastened to or released from each other and is able to be easily fastened or released from one member while the adapter is connected to the other member.

### BRIEF DESCRIPTION OF THE DRAWNIGS

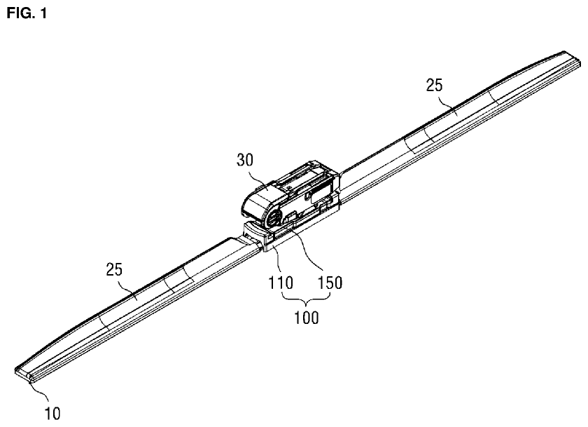

FIG. 1 is a perspective view illustrating a wiper device according to an embodiment of the present invention.

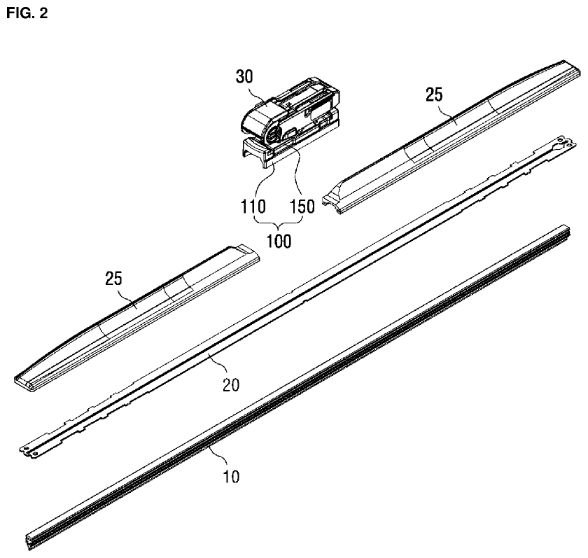

FIG. 2 is an exploded view illustrating a wiper device according to an embodiment of the present invention.

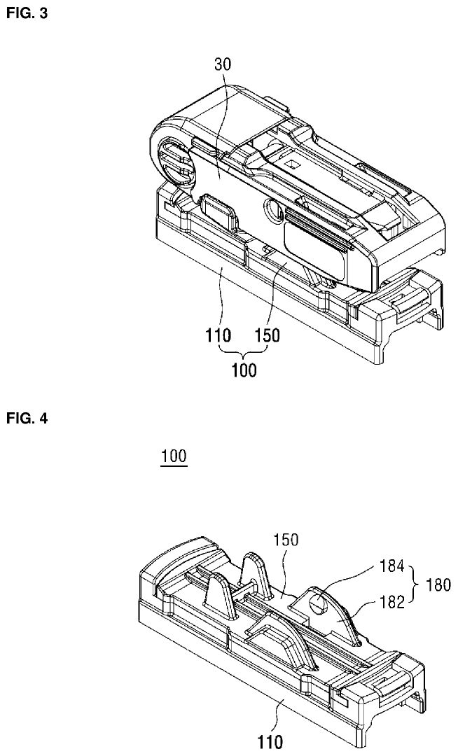

FIG. 3 and FIG. 4 are diagrams illustrating an adapter and an adapter coupling member in a wiper device according to an embodiment of the present invention.

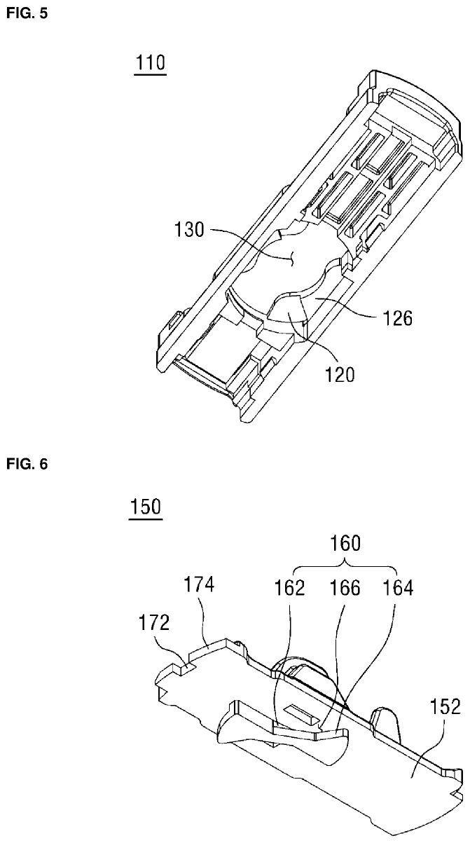

FIG. 5 is a diagram illustrating a first coupling member of an adapter coupling member in a wiper device according to an embodiment of the present invention.

FIG. 6 is a diagram illustrating a second coupling member of an adapter coupling member in a wiper device according to an embodiment of the present invention.

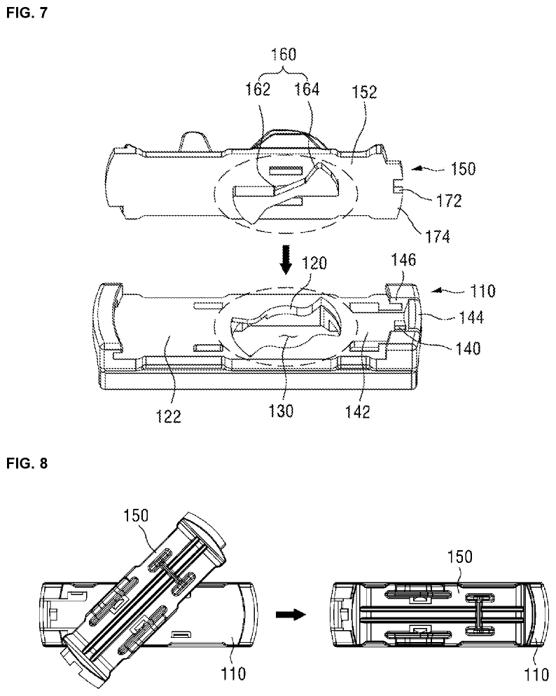

FIG. 7 to FIG. 9 are diagrams illustrating fastening of an adapter coupling member in a wiper device according to an embodiment of the present invention.

FIG. 10 is a diagram illustrating an alignment part in a wiper device according to an embodiment of the present invention.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The terms used in the description are intended to describe certain embodiments only, and shall by no means restrict the present disclosure. Unless clearly used otherwise, expressions in the singular number include a plural meaning. In the present description, an expression such as “comprising” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, the embodiment of the present invention will be described in detail with reference to the accompanying drawings.

FIG. 1 is a perspective view illustrating a wiper device according to an embodiment of the present invention and FIG. 2 is an exploded view illustrating a wiper device according to an embodiment of the present invention.

A wiper device according to an embodiment of the present invention may be configured for removing a foreign substance attached to a windshield and may include a contact member 10, a support member 20, an adapter 30, and an adapter coupling member 100.

The contact member 10 of this embodiment may be a part that is in close contact with the windshield to wipe off a foreign substance, and the contact member 10 may include any of various known contact members such as a wiper blade made of a rubber material.

The support member 20 may be a part that elastically supports the contact member 10 so that the contact member 10 is in close contact with the windshield. The support member 20 may be a tournament structure in which a plurality of levers are connected by hinges. The support member 20 may be also a flat structure made of a leaf spring. The support member 20 may be also a hybrid structure in which the tournament structure and the flat structure are combined.

As shown in FIG. 2, in this embodiment, a leaf spring having a predetermined curvature and elasticity in accordance with the shape of the windshield may be used for the support member 20 to allow the contact member 10, i.e., the wiper blade, to be tightly in contact with the curved surface of the windshield.

The cover member 25 may be also coupled to the support member 20.

The adapter 30 may be a part for connecting a wiper arm (not shown) to the wiper device. For example, the adapter 30 may be coupled to the adapter coupling member 100 and the wiper arm may be detachably connected to the adapter 30.

FIG. 3 and FIG. 4 are diagrams illustrating an adapter and an adapter coupling member in a wiper device according to an embodiment of the present invention.

Regarding to FIG. 3 and FIG. 4, the adapter coupling member 100 may include an adapter connection part 180, and the adapter 30 may be pivotally coupled to the adapter connection part 180.

For example, a pair of walls 182 facing each other may be formed on the second coupling member 150 of the adapter coupling member 100, and a rotation shaft 184 may be formed on the pair of walls 182. Here, the adapter 30 may be fitted to the rotation shaft 184 to enable pivoting.

The adapter coupling member 100 may be a part for coupling the adapter 30 to the support member 20. The adapter coupling member 100 may have a structure in which the first coupling member 110 and the second coupling member 150 are fastened or released. Particularly, the first coupling member 110 may be coupled to the support member 20, and the second coupling member 150 coupled to the adapter 30 may be inserted into the first coupling member 110 and then rotated to be fastened or released.

In this embodiment, a coupling hole 130 may be formed in the first coupling member 110, and a coupling protrusion 160 to be inserted into the coupling hole 130 may be formed in the second coupling member 150. After inserting the coupling protrusion 160 into the coupling hole 130, the coupling protrusion 160 may be fastened to the first coupling member 110. In particular, fastening of the coupling protrusion 160 in this embodiment may be performed simultaneously with the alignment of the first coupling member 110 and the second coupling member 150.

FIG. 5 is a diagram illustrating a first coupling member of an adapter coupling member in a wiper device according to an embodiment of the present invention, and FIG. 6 is a diagram illustrating a second coupling member of an adapter coupling member in a wiper device according to an embodiment of the present invention.

FIG. 7 to FIG. 9 are diagrams illustrating fastening of an adapter coupling member in a wiper device according to an embodiment of the present invention.

Regarding to FIG. 5 and FIG. 7, the first coupling member 110 may include an upper wall 120 having an upper surface 122 on which the second coupling member 150 is seated. Here, the coupling hole 130 may be formed to penetrate the upper wall 120.

Referring to FIG. 6, the second coupling member 150 may include a lower surface 152 facing the upper surface 122 of the first coupling member 110. The coupling protrusion 160 may be formed to protrude from the lower surface 152, and a fastening groove 166 may be formed on a side surface of the coupling protrusion 160.

For example, a rod-shaped member 162 protruding in a longitudinal direction may be formed on the lower surface 152 of the second coupling member 150, and a plate-shaped member 164 may be formed on a side surface of the rod-shaped member 162 in a wing shape. That is, the coupling protrusion 160 may include the rod-shaped member 162 and the plate-shaped member 164 protruding from the rod-shaped member 162 to the side. Here, an empty space may be formed between the lower surface 152 of the second coupling member 150 and the plate-shaped member 164 to form a fastening groove 166. A width of the space between the lower surface 152 of the second coupling member 150 and the plate-shaped member 164 may be determined in accordance with a thickness of the upper wall 120 of the first coupling member 110 to be inserted.

An overall appearance of the coupling protrusion 160 may be formed in accordance with the shape of the coupling hole 130 in order to insert the coupling protrusion 160 into the coupling hole 130. Similar to the relationship between a key groove and a key, the outlines of the coupling hole 130 and the coupling protrusion 160 may be formed similarly to each other so that insertion may become possible at a certain position.

Regarding to FIG. 7 and FIG. 8, when the second coupling member 150 is disposed at a certain angle with respect to the first coupling member 110 based on the longitudinal direction of the wiper device, the coupling protrusion 160 may be fitted and inserted into the coupling hole 130.

After inserting the coupling protrusion 160 into the coupling hole 130, the second coupling member 150 may be fastened to the first coupling member 110 by rotating the second coupling member 150 with respect to the first coupling member 110. Here, while the second coupling member 150 rotates, the upper wall 120 of the first coupling member 110 may be fitted into the fastening groove 166 of the second coupling member 150.

In this embodiment, the second coupling member 150 may be rotated in a direction opposite to the angle shifted from the first coupling member 110, so that the first coupling member 110 and the second coupling member 150 may be aligned in the longitudinal direction of the wiper, and the first coupling member 110 and the second coupling member 150 may be fastened at the same time. The first coupling member 110 and the second coupling member 150 may be also released from the coupling by rotating the second coupling member 150 in the opposite direction to the fastened direction.

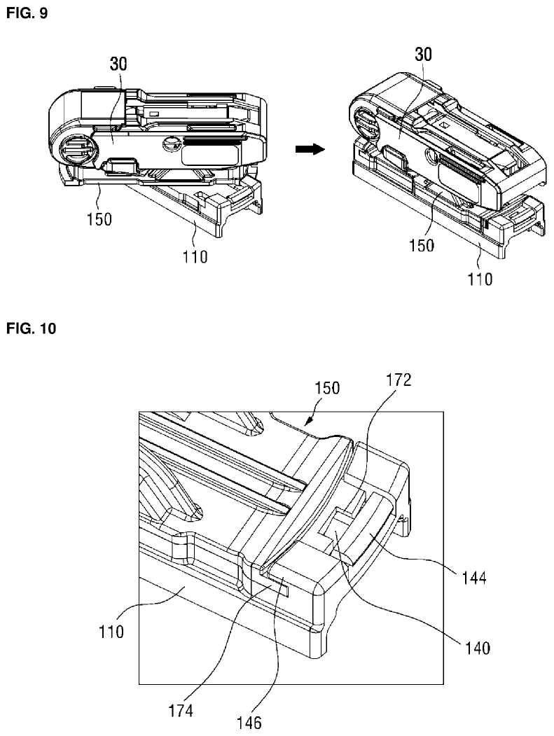

In particular, referring to FIG. 9, in a state in which the adapter 30 is coupled to the second coupling member 150, the second coupling member 150 may be easily fastened to or released from the first coupling member 110, so that the adapter may be easily mounted.

On the other hand, referring to FIG. 5, a stepped portion 126 thicker than the width of the fastening groove 166 may be formed on the rear surface (the opposite surface of the upper surface) of the upper wall 120 in the first coupling member 110. The stepped portion 126 may block the plate-shaped member 164 of the coupling protrusion 160 when the second coupling member 150 rotates, thereby stopping the rotation of the second coupling member 150 at a specific position. Accordingly, a stopper structure for stopping further rotation of the second coupling member 150 may be formed when the second coupling member 150 is aligned with the first coupling member 110.

In addition, the wiper device may further include an alignment part configured for fixing the position of the second coupling member 150 to the first coupling member 110 at an alignment position of the second coupling member 150 with respect to the first coupling member 110.

FIG. 10 is a diagram illustrating an alignment part in a wiper device according to an embodiment of the present invention.

Regarding to FIG. 7 and FIG. 10, the alignment part of the present embodiment may include an alignment protrusion 140 protruding from the upper surface 122 of the first coupling member 110 and elastically supported, and an alignment groove 172 formed in the second coupling member 150 and into which the alignment protrusion 140 is inserted.

When the first coupling member 110 and the second coupling member 150 are aligned in the longitudinal direction of the wiper, the alignment protrusion 140 may be inserted into the alignment groove 172 to be fixed in the position where the second coupling member 150 is aligned.

Here, the alignment protrusion 140 may be formed on a cantilever 142 made of an elastic material to be elastically supported. In addition, a button 144 having a protruding structure may be formed at an end of the cantilever 142. When the button 144 is pressed, the alignment protrusion 140 may be removed from the alignment groove 172. Therefore, when the second coupling member 150 is released from the first coupling member 110, the alignment part may be released by pressing the button 144 and the second coupling member 150 may be rotated to separate it.

On the other hand, when the first coupling member 110 and the second coupling member 150 are aligned in the longitudinal direction of the wiper, a part of the end of the second coupling member 150 may be inserted and fixed into the first coupling member 110.

Referring to FIG. 7, an insertion part 174 may be formed at a longitudinal end of the second coupling member 150, and a concave receiving part 146 into which the insertion part 174 is inserted may be formed at a longitudinal end of the first coupling member 110. The receiving part 146 may have a side surface-opened structure, so that when the second coupling member 150 is rotated and aligned, the insertion part 174 may be inserted into the side surface of the receiving part 146 to be fitted. Accordingly, a problem in which the end of the second coupling member 150 is lifted from the first coupling member 110 may be prevented.

Although an embodiment of the present invention has been described, it shall be appreciated that various permutations and modifications are possible by those of ordinary skill in the art to which the present invention pertains without departing from the technical ideas and scopes of the present invention that are defined by the claims appended below.

It shall be also appreciated that there can be many other embodiments than the embodiment described above in the claims of the present invention.

### DESCRIPTION OF ELEMENTS

10: Contact member

20: Support member

25: Cover member

30: Adapter

100: Adapter coupling member

110: First coupling member

120: Upper wall

130: Coupling hole

140: Alignment protrusion

150: Second coupling member

160: Coupling protrusion

166: Fastening groove

172: Alignment groove

What is claimed is:

1. A wiper device coupled to a wiper arm to remove a foreign substance, comprising:
a contact member configured to wipe off the foreign substance;
a support member configured to elastically support the contact member to be in close contact with a windshield;
an adapter coupled to the wiper arm; and
an adapter coupling member comprising a first coupling member coupled to the support member and a second coupling member coupled to the adapter and rotated to be fastened and released after being fitted into the first coupling member.

2. The wiper device of claim 1, wherein a coupling hole is formed in the first coupling member,
wherein a coupling protrusion is formed in the second coupling member to be inserted into the coupling hole, and
wherein after the coupling protrusion is inserted into the coupling hole, the coupling protrusion is fastened to the first coupling member when aligning the first coupling member and the second coupling member by rotating the second coupling member.

3. The wiper device of claim 2, wherein the first coupling member comprises an upper wall having an upper surface on which the second coupling member is seated and the coupling hole penetrates the upper wall,
wherein the second coupling member comprises a lower surface facing the upper surface, the coupling protrusion protrudes from the lower surface, and a fastening groove is formed on a side surface of the coupling protrusion, and
wherein when the second coupling member is rotated with respect to the first coupling member after inserting the coupling protrusion into the coupling hole, the upper wall of the first coupling member is fitted into the fastening groove of the second coupling member.

4. The wiper device of claim 2, further comprising an alignment part configured for fixing the position of the second coupling member to the first coupling member at an alignment position of the second coupling member with respect to the first coupling member.

5. The wiper device of claim 4, wherein the alignment part comprises an alignment protrusion protruding from an upper surface of the first coupling member and elastically supported; and an alignment groove formed in the second coupling member and into which the alignment protrusion is inserted.
